(19) United States
(12) Patent Application Publication
(10) Pub. No.: US 2011/0225556 A1
(43) Pub. Date: Sep. 15, 2011

(54) PACKAGE SUBSTRATE DESIGN DEVICE, PACKAGE SUBSTRATE DESIGN METHOD, AND COMPUTER READABLE RECORDING MEDIUM FOR RECORDING PACKAGE SUBSTRATE DESIGN PROGRAM

(75) Inventor: Toyokazu Shibata, Kawasaki-Shi (JP)

(73) Assignee: Kabushiki Kaisha Toshiba, Tokyo (JP)

(21) Appl. No.: 12/887,314

(22) Filed: Sep. 21, 2010

(30) Foreign Application Priority Data
Mar. 12, 2010 (JP) 2010-55572

(51) Int. Cl. G06F 9/45

(52) U.S. Cl. 716/103

(57) ABSTRACT

According to one embodiment, a package substrate design device includes a first wiring module, a net generator, a second wiring module, and a third wiring module. The first wiring module is configured to generate a plurality of first vias configured to connect wires on the first wiring layer and wires on the second wiring layer and configured to generate a plurality of first wires configured to connect the first vias and the first terminals. The net generator is configured to generate nets for connecting the second terminals and k-th (k is an integer of 1 to (n−2)) vias. The second wiring module is configured to generate a plurality of (k+1)-th vias configured to connect wires on the (k+1)-th wiring layer and wires on the (k+2)-th wiring layer and configured to generate a plurality of (k+1)-th wires configured to connect the (k+1)-th vias and the k-th vias, the (k+1)-th vias and the (k+1)-th wires being generated between the k-th vias and the second terminals connected by the nets. The third wiring module is configured to generate a plurality of n-th wires configured to connect the (n−1)-th vias and the second terminals.

### CROSS REFERENCE TO RELATED APPLICATIONS

This application is based upon and claims the benefit of priority from the prior Japanese Patent Application No. 2010-55572 filed on Mar. 12, 2010, the entire contents of which are incorporated herein by reference.

### FIELD

Embodiments described herein relate generally to a package substrate design device, a package substrate design method, and a computer readable recording medium for recording package substrate design.

### BACKGROUND

Generally, an IC chip is mounted on a printed circuit board (PCB) in a packaged state. Bond fingers, which are connected to input/output terminals of the IC chip, are formed on the top surface of the package substrate on which the IC chip is mounted. Further, balls, which are connected to the PCB, are formed on the bottom surface of the package substrate. Therefore, nets should be generated to electrically connect the bond fingers on the top surface of the package substrate and the balls on the bottom surface of the package substrate.

In order to design a product in a short period, it is required to determine which ball on the package substrate should be assigned to which input/output terminal of the IC chip at an early stage.

JP-A No. 2002-269165 (Kokai) (hereinafter referred to as Patent Document 1) discloses a technique in which wires for connecting the bond fingers and the balls are automatically generated one by one. In this technique, the region where a wire is already formed is treated as a wiring-prohibited region, and the following wire is generated away from the wiring-prohibited region. However, in recent years, it is usual that the IC chip has hundreds to thousand input/output terminal pins. In order to connect many bond fingers and balls, the number of wiring layers of the package substrate becomes greater (four or greater, for example) and wiring becomes extremely complicated. In this case, the technique of Patent Document 1 causes a problem that the wiring-prohibited region becomes larger as more nets are generated, by which rearrangement of wiring is often required due to frequent detouring and deviation from design rules.

Therefore, actually, the nets should be manually generated when the number of wiring layers is large, and thus a long time is required to design the package.

### BRIEF DESCRIPTION OF THE DRAWINGS

FIG. 1 is a sectional view of a PBGA 10.

FIG. 2 is a schematic block diagram of a design system including a package substrate design device 100 according to an embodiment.

FIG. 3 is a schematic block diagram of the design device 100.

FIG. 4 is a flowchart showing an example of the processing operation of the design device 100 of FIG. 3.

FIG. 5 is a diagram showing an example of the initial nets generated by the top layer wiring module 41.

FIG. 6 is a diagram showing an example of the first wires and the first vias generated by the top layer wiring module 41.

FIG. 7 is a diagram showing an example of the rat's nests generated so that the number of intersections is equal to or smaller than a predetermined value.

FIG. 8 is a diagram showing an example of the second wires and the second vias generated by the intermediate layer wiring module 43.

FIG. 9 is a diagram showing an example of rat's nests generated so that the number of intersections is equal to or smaller than a predetermined value.

FIG. 10 is a diagram showing an example of the third wires and the third vias generated by the intermediate layer wiring module 43.

FIG. 11 is a diagram showing an example of the fourth wires generated by the bottom layer wiring module 44.

FIG. 12 is a diagram showing the first package substrate net information for FIG. 11.

FIG. 13 is a diagram showing the second package substrate net information for FIG. 11.

### DETAILED DESCRIPTION

In general, according to one embodiment, a package substrate design device for generating nets through a dielectric substrate having first to n-th (n is an integer of 3 or greater) wiring layers and first to (n−1)-th dielectric layers each being inserted between the wiring layers adjacent to each other, the nets being generated between a plurality of first terminals formed on the top surface of the first wiring layer of the dielectric substrate and a plurality of second terminals formed on the bottom surface of the n-th wiring layer of the dielectric substrate includes a first wiring module, a net generator, a second wiring module, and a third wiring module. The first wiring module is configured to generate, through the first dielectric layer, a plurality of first vias configured to connect wires on the first wiring layer and wires on the second wiring layer and configured to generate, on the first wiring layer, a plurality of first wires configured to connect the first vias and the first terminals. The net generator is configured to generate nets for connecting the second terminals and k-th (k is an integer of 1 to (n−2)) vias. The second wiring module is configured to generate, through the (k+1)-th dielectric layer, a plurality of (k+1)-th vias configured to connect wires on the (k+1)-th wiring layer and wires on the (k+2)-th wiring layer and configured to generate, on the (k+1)-th wiring layer, a plurality of (k+1)-th wires configured to connect the (k+1)-th vias and the k-th vias, the (k+1)-th vias and the (k+1)-th wires being generated between the k-th vias and the second terminals connected by the nets. The third wiring module is configured to generate, on the n-th wiring layer, a plurality of n-th wires configured to connect the (n−1)-th vias and the second terminals.

Hereinafter, an embodiment of a package substrate design device, a package substrate design method and a computer readable recording medium for recording package substrate design will be concretely explained referring to the drawings.

First, the structure of a PBGA (Plastic Ball Grid Array), which is a kind of package capable of being designed by the present embodiment, will be explained.

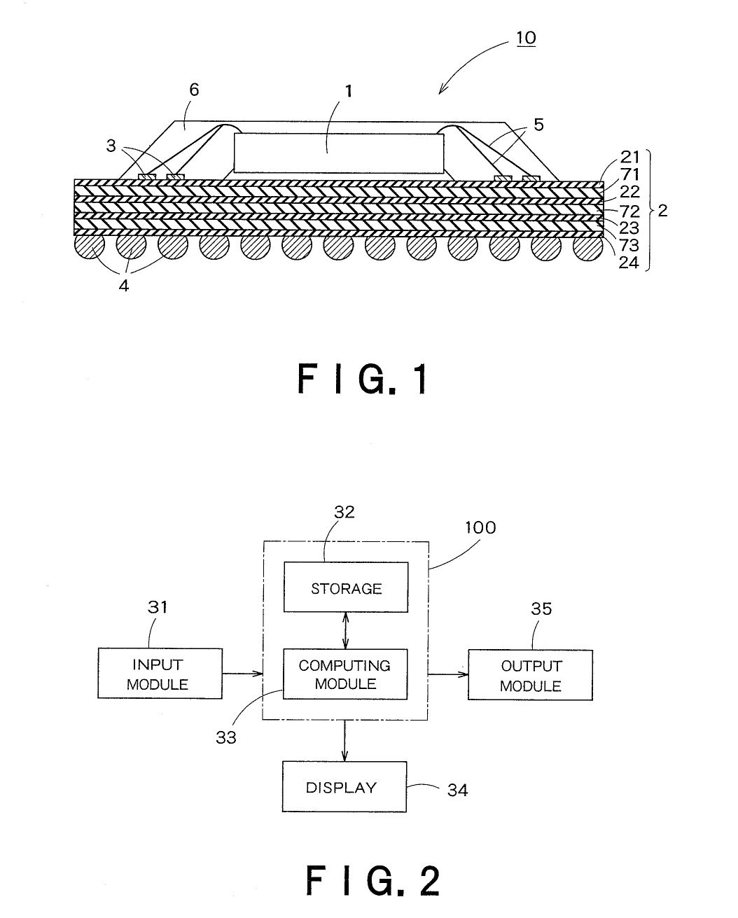

FIG. 1 is a sectional view of a PBGA 10. The PBGA 10 has a package substrate (dielectric substrate) 2, bond fingers 3, balls 4, bonding wires, and a molded resin 6. An IC chip 1 is mounted on the package substrate 2.

The package substrate 2, which includes a dielectric layer, is formed of first to fourth wiring layers 21 to 24 and first to third dielectric layers 71 to 73 each being inserted between the wiring layers adjacent to each other. Wires (not shown) are formed on the first to fourth wiring layers 21 to 24 while vias (not shown) are formed through the first to third dielectric layers 71 to 73. The bond fingers 3 and the balls 4 are electrically connected through the wires and the vias, respectively.

The bond fingers 3 are formed on the top surface of the package substrate 2, and are connected to input/output terminals of the IC chip 1 through the bonding wires 5. The balls 4 are formed on the bottom surface of the package substrate 2. The PBGA 10 is mounted on a PCB (not shown), for example, and the balls 4 are connected to other elements mounted on the same PCB. Further, the balls 4 are connected to the bond fingers 3 through the wires and the vias formed in the package substrate 2. That is, the balls 4 are electrically connected to the input/output terminals of the IC chip 1 through the bond fingers 3. Further, the molded resin 6 seals the IC chip 1, the package substrate 2, the bond fingers 3, and the bonding wires 5, and insulates these components from one another.

The substrate design device according to the present embodiment is provided to design the nets and wiring patterns formed in the first to fourth wiring layers 21 to 24 and the first to third dielectric layers 71 to 73 of FIG. 1 to connect the bond fingers (first terminals) 3 and the balls (second terminals) 4. Note that a net means the relationship of logical connection between two points (one of the bond fingers 3 and one of the balls 4, for example), and does not necessarily means a physical wire.

The example shown below relates to the design for the package substrate 2 formed of four wiring layers 21 to 24 and three dielectric layers 71 to 73 shown in FIG. 1, and the applicable number of wiring layers is three or greater. For example, a package substrate formed of six or eight wiring layers can be designed.

FIG. 2 is a schematic block diagram of a design system including a package substrate design device (hereinafter referred to as design device) 100 according to an embodiment. The design system of FIG. 2 has an input module 31, the design device 100 having a storage 32 and a computing module 33, a display 34, and an output module 35.

The input module 31 is a keyboard, mouse, etc. to input the coordinates of the bond fingers 3 and the balls 4 and design rules for the package substrate. The design rules determine the restrictions on the minimum line width of a wire, the size of a via, etc. The storage 32 stores the inputted coordinates of the bond fingers 3 etc. The computing module 33 designs the nets and wiring patterns of the package substrate 2. The storage 32 and the computing module 33 are incorporated in one or a plurality of computers, for example. The display 34 is a liquid crystal display, for example, to display the nets and wiring patterns obtained by the computing module 33. The output module 35 is a printer, for example, to print the nets and wiring patterns obtained by the computing module 33.

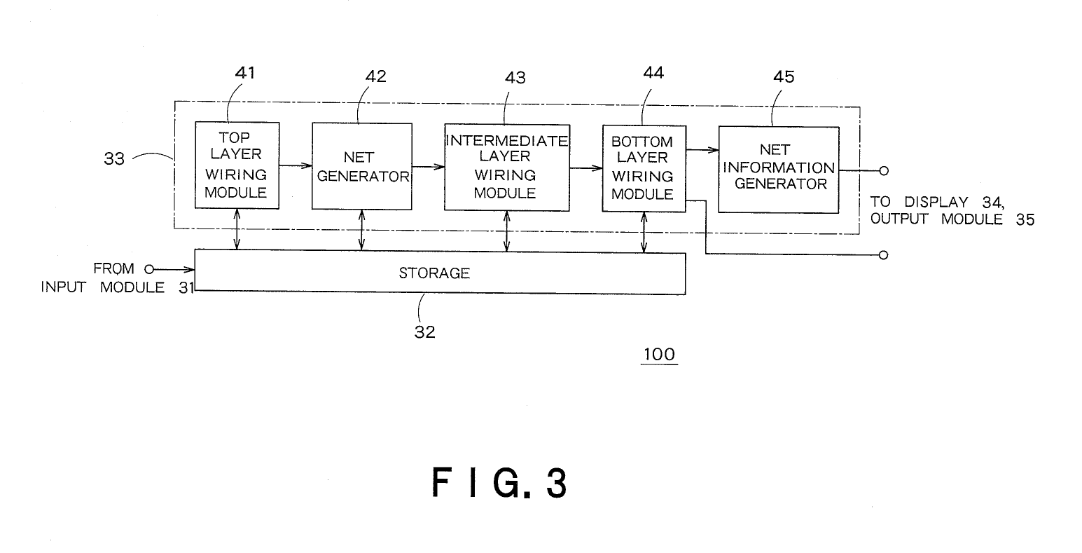

FIG. 3 is a schematic block diagram of the design device 100. The design device 100 includes: the storage 32; a top layer wiring module (first wiring module) 41; a net generator 42; an intermediate layer wiring module (second wiring module) 43; a bottom layer wiring module 44 (third wiring module) 44; and a net information generator 45.

The top layer wiring module 41 generates wires on the first wiring layer 21 of FIG. 1, and generates vias through the first dielectric layer 71 of FIG. 1. The net generator 42 generates the nets between the bond fingers 3 and the vias. The intermediate layer wiring module 43 generates wires on the second and third wiring layers 22 and 23, and generates vias through the second and third dielectric layers 72 and 73. The bottom layer wiring module 44 generates wires on the fourth wiring layer 24. The net information generator 45 generates net information showing the relationship of connection between the bond fingers 3 and the balls 4, and outputs the net information to the display 34 and the output module 35.

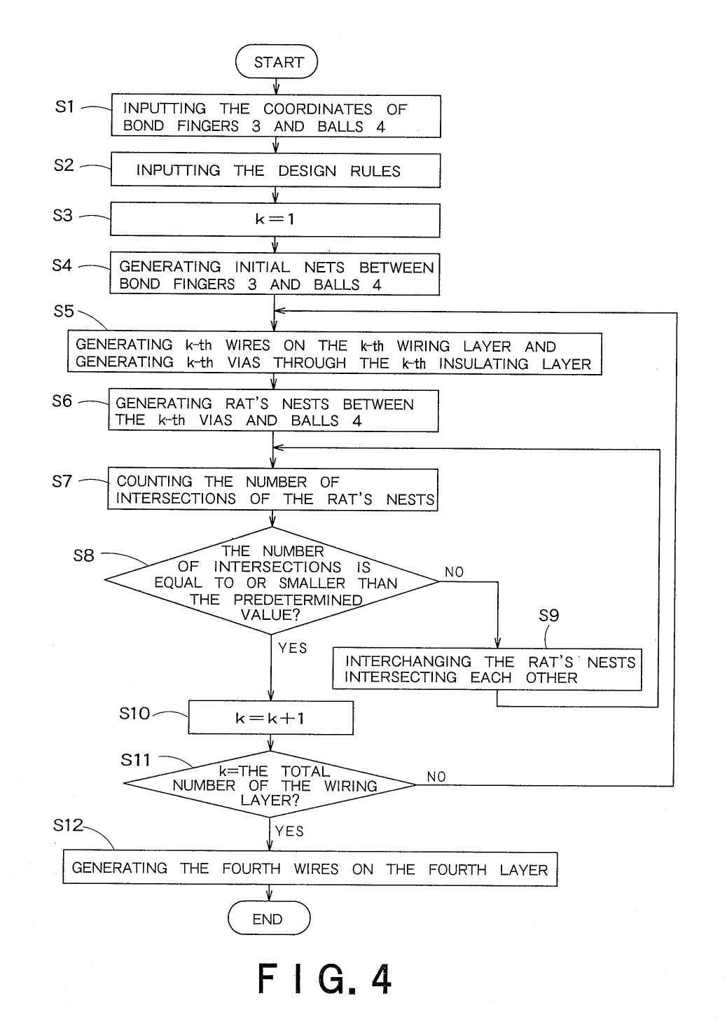

FIG. 4 is a flowchart showing an example of the processing operation of the design device 100 of FIG. 3.

Firstly, the coordinates of the bond fingers 3 and the balls 4 (Step 51) and design rules for the package substrate 2 (Step S2) are inputted by the input module 31 of FIG. 2, and are stored in the storage 32. Then, a parameter “k” is set to be “1” (Step S3). Note that the parameter “k” represents the number of wiring layers and dielectric layers.

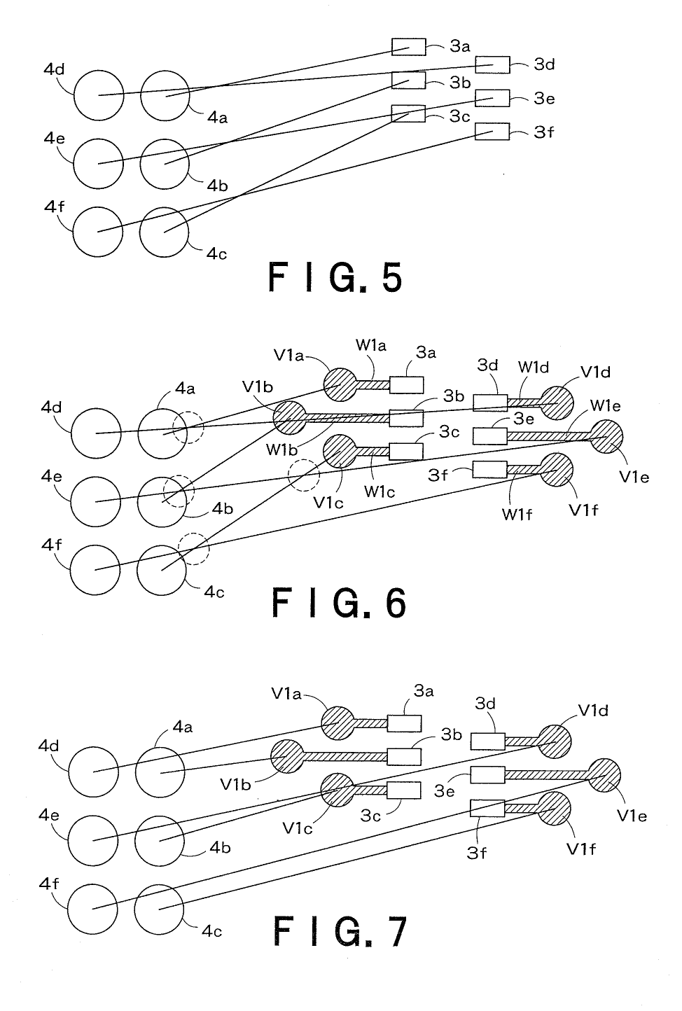

Next, the top layer wiring module 41 generates initial nets between the bond fingers 3 and the balls 4, respectively (Step S4). FIG. 5 is a diagram showing an example of the initial nets generated by the top layer wiring module 41. Hereinafter, an example will be shown where six bond fingers 3a to 3f and six balls 4a to 4f are connected. The technique for generating the initial nets is not particularly questioned. For example, the initial net is a net generated between the bond finger 3 and the ball 4 thereby. Alternatively, the initial net may be a net generated between the bond finger 3 and the ball 4 which are arranged on a straight line radially extending from a predetermined point (the center of the IC chip 1, for example). In FIG. 5, the initial nets are generated between the bond fingers 3a to 3f and the balls 4a to 4f, respectively.

Further, the top layer wiring module 41 generates wiring patterns of the first wiring layer 21 and the first dielectric layer 71 so that the wires are directed from the bond fingers 3 to the balls 4 between which the initial nets are generated while satisfying the design rules stored in the storage 32. More specifically, first vias are generated through the first dielectric layer 71 to connect the wires on the first wiring layer 21 and the wires on the second wiring layer 22, and first wires are generated on the first wiring layer 21 to connect the first vias and the bond fingers 3 (Step S5 in FIG. 4).

FIG. 6 is a diagram showing an example of the first wires and the first vias generated by the top layer wiring module 41. In FIG. 6, the first vias V1a to V1c are generated to generate the wires directed from the bond fingers 3a to 3c to the balls 4a to 4c, respectively, and the first wires W1a to W1c are generated to connect the first vias V1a to V1c and the bond fingers 3a to 3c, respectively.

Further, the first vias V1d to V1f are generated, and the first wires W1d to W1f are generated to connect the first vias V1d to V1f and the bond fingers 3d to 3f, respectively. The first vias V1d to V1f are formed in the positions shown in FIG. 6 because the design rules do not allow to generate the first vias V1d to V1f in the direction from the bond fingers 3d to 3f to the balls 4d to 4f due to the positions of the bond fingers 3a to 3c and the first wires W1a.

In this way, the wiring patterns of the first wiring layer 21 and the first dielectric layer 71 are completely generated.

Next, the net generator 42 generates straight-line nets between the balls 4 and the first vias connected to the bond fingers 3, the bond fingers 3 and the balls 4 being connected by the initial nets (Step S6 in FIG. 4). Hereinafter, the net connecting two points by a straight line is called a rat's nest. FIG. 6 also shows the rat's nests. For example, the ball 4a is connected to the bond finger 3a by the initial net (FIG. 5). Further, the bond finger 3a is connected to the first via V1a. Therefore, the net generator 42 generates a rat's nest between the ball 4a and the first via V1a. As stated above, in FIG. 6, six rat's nests are generated between six balls 4a to 4f and six first vias V1a to V1f, respectively.

Next, the net generator 42 counts the number of intersections of the rat's nests (Step S7 in FIG. 4). In FIG. 6, the rat's nests are intersected at four points (circled by broken lines in FIG. 6). The net generator 42 determines whether or not the number of intersections is equal to or smaller than a predetermined value (Step S8). When the number of intersections exceeds the predetermined value (Step S8—NO), the net generator 42 interchanges the rat's nests intersecting each other (Step S9). Then the net generator 42 counts the number of intersections again (Step S7), and determines whether or not the number of intersections is the predetermined value or smaller (Step S8). The net generator 42 repeats the processings of Steps S7 to S9 until the number of intersections is equals to or smaller than the predetermined value.

FIG. 7 is a diagram showing an example of the rat's nests generated so that the number of intersections is equal to or smaller than a predetermined value. In FIG. 7, an example is shown where the number of intersections is “0”. In FIG. 7, the rat's nests are generated between the ball 4a and the first via V1b, and between the ball 4b and the first via V1c, for example.

The net generator 42 counts the number of intersections and interchanges the rat's nests intersecting each other, which is a simple process. Therefore, the rat's nests of FIG. 7 can be automatically generated without requiring any manpower.

Note that it is also possible to try to interchange the rat's nests intersecting each other for every possible pattern to generate the rat's nests so that the number of intersections becomes the smallest, instead of performing Steps S8 and S9 in FIG. 4.

Next, the parameter “k” is incremented by “1” and is set to be “2” (Step S10). The parameter “k” is not equal to “4”, which is the number of wiring layers (Step S11—NO). Accordingly, the intermediate layer wiring module 43 generates wiring patterns of the second wiring layer 22 and the second dielectric layer 72 so that the wires are directed from the first vias V1a to V1f to the balls 4 between which the rat's nests are generated while satisfying the design rules. More specifically, second vias are generated through the second dielectric layer 72 to connect the wires on the second wiring layer 22 and the wires on the third wiring layer 23, and second wires are generated on the second wiring layer 22 to connect the first vias and the second vias (Step S5).

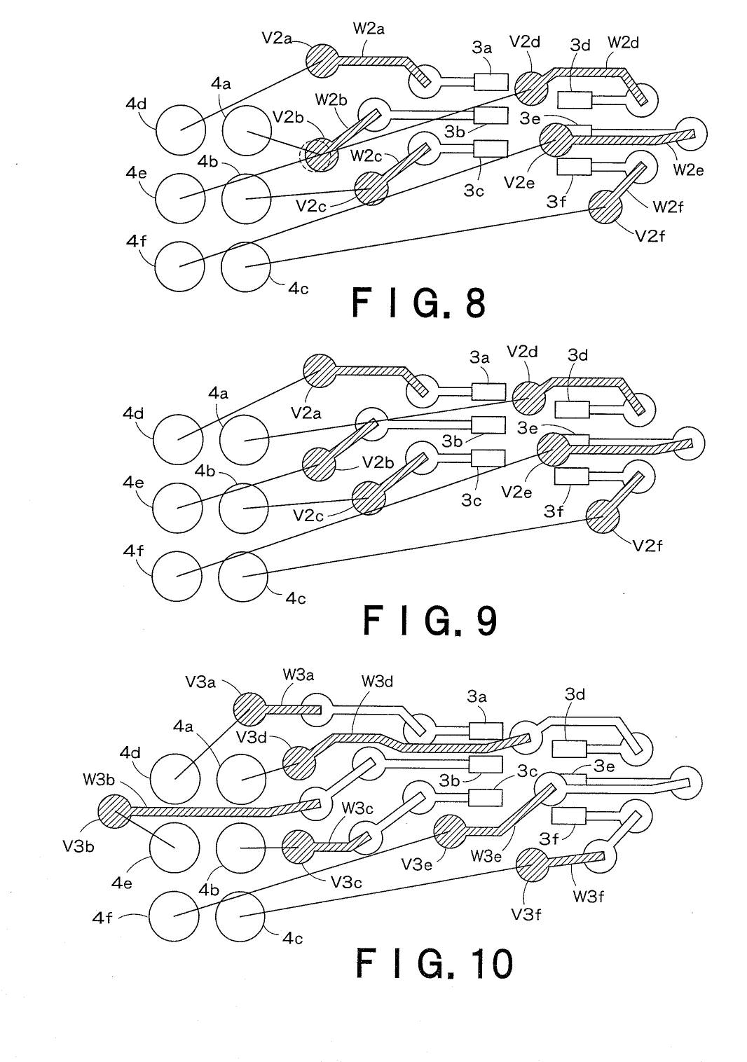

FIG. 8 is a diagram showing an example of the second wires and the second vias generated by the intermediate layer wiring module 43. In FIG. 8, the second wires W2a to W2f generated on the second wiring layer 22 and the second vias V2a to V2f generated through the second dielectric layer 72 are shown by diagonal lines. In this way, the wiring patterns of the second wiring layer 22 and the second dielectric layer 72, which are the second layer, are completely generated. Since the number of intersections of the rat's nests is made to be equal to or smaller than the predetermined number in Step S8, the wires on the wiring layer 22 can be prevented from being complicated and the length thereof is not excessively extended.

Next, the steps starting from Step S6 are performed, and the process of Steps S6 to S11 will be simply explained since the process is as mentioned above.

The net generator 42 generates straight-line nets between the balls 4 and the second vias connected to the bond fingers 3, the bond fingers 3 and the balls 4 being connected by the rat's nests (Step S6). FIG. 8 also shows the rat's nests.

Next, the net generator 42 counts the number of intersections of the rat's nests (Step S7 in FIG. 4). In FIG. 8, the rat's nests are intersected at one point (circled by a broken line in FIG. 8). The net generator 42 determines whether or not the number of intersections is equal to or smaller than the predetermined value (Step S8), and interchanges the rat's nests intersecting each other until the number of intersections is equal to or smaller than the predetermined value.

FIG. 9 is a diagram showing an example of rat's nests generated so that the number of intersections is equal to or smaller than a predetermined value. In FIG. 7, an example is shown where the number of intersections is “0”.

Next, the parameter “k” is set to be “3” (Step 51 in FIG. 4). The parameter “k” is not equal to “4”, which is the number of wiring layers (Step S11—NO). Accordingly, the intermediate layer wiring module 43 generates wiring patterns of the third wiring layer 23 and the third dielectric layer 73 so that the wires are directed from the second vias V2a to V2f to the balls 4 between which the rat's nests are generated while satisfying the design rules. More specifically, third vias are generated through the third dielectric layer to connect the wires on the third wiring layer 23 and the wires on the fourth wiring layer 24, and third wires are generated on the third wiring layer 23 to connect the second vias and the third vias (Step S5).

FIG. 10 is a diagram showing an example of the third wires and the third vias generated by the intermediate layer wiring module 43. In FIG. 10, the third wires W3a to W3f generated on the third wiring layer 23 and the third vias V3a to V3f generated through the third dielectric layer 73 are shown by diagonal lines. In this way, the wiring patterns of the third wiring layer 23 and the third dielectric layer 73 are completely generated.

Next, the net generator 42 generates straight-line nets between the balls 4 and the third vias connected to the bond fingers 3, the bond fingers 3 and the balls 4 being connected by the rat's nests (Step S6). FIG. 10 also shows the rat's nests.

Next, the net generator 42 counts the number of intersections of the rat's nests (Step S7 in FIG. 4). In FIG. 10, there is no intersection in the rat's nests (Step S8—NO). Accordingly, the net generator 42 does not interchange any rat's nest.

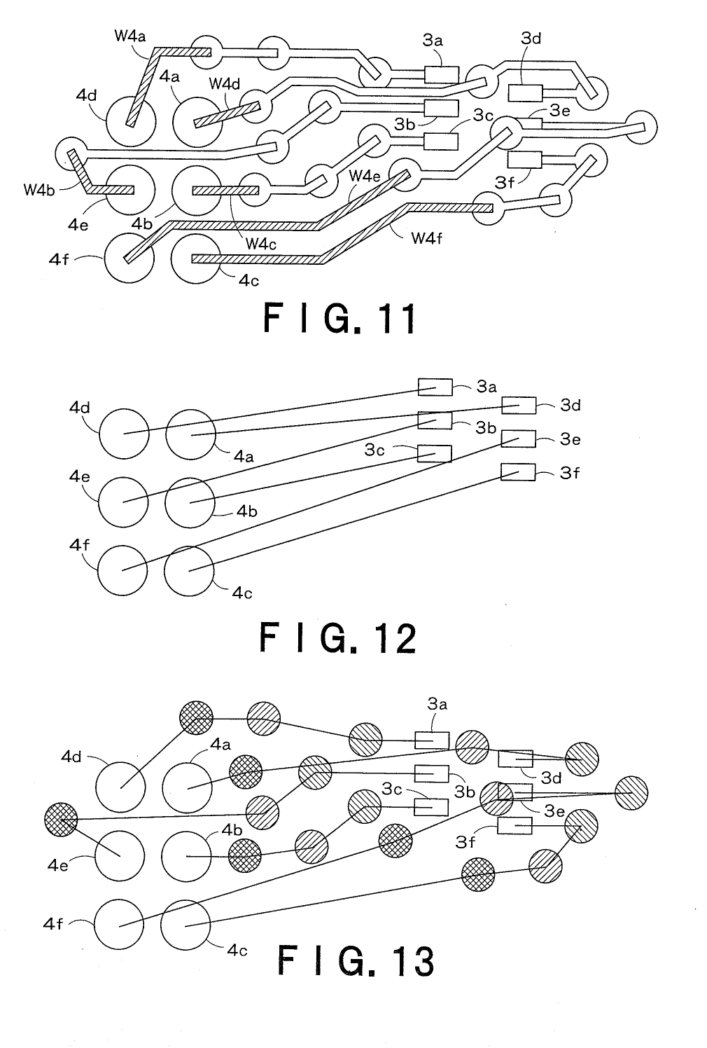

Next, the parameter “k” is set to be “4” (Step S10). The parameter “k” is equal to “4”, which is the number of wiring layers (Step S11—YES). Accordingly, the bottom layer wiring module 44 generates fourth wires on the fourth wiring layer 24 to connect the third vias and the balls 4a to 4f (Step S12). FIG. 11 is a diagram showing an example of the fourth wires generated by the bottom layer wiring module 44. In FIG. 11, the fourth wires W4a to W4f generated on the fourth wiring layer 24 are shown by diagonal lines. In this way, the wires on the fourth wiring layer 24 are completely generated.

Note that, when the number of wiring layers is larger than four, repetition of the processing operation of Steps S5 to S11 is required.

As stated above, the wiring patterns for connecting the bond fingers 3a to 3f and the balls 4a to 4f are generated in the package substrate 2. As shown in FIG. 11, connection is finally achieved between the following bond fingers and the balls: 3a and 4d; 3b and 4e; 3c and 4b; 3d and 4a; 3e and 4f; and 3f and 4c.

Based on FIG. 11, it is possible to make masks to form the wires on the first to fourth wiring layers 21 to 24 and to form the vias through the first to third dielectric layers 71 to 73.

Further, the net information generator 45 generates first package substrate net information for connecting, by straight lines, the bond fingers 3a to 3f and the balls 4a to 4f through the first to fourth wires and the first to the third vias. FIG. 12 is a diagram showing the first package substrate net information for FIG. 11. The first package substrate net information shows the relationship of connection between the bond fingers 3 and the balls 4. Accordingly, the correspondence relation between the balls 4 and the input/output terminals of the IC chip 1 is made clear, which can be effective in PCB design etc.

Further, the net information generator 45 generates second package substrate net information for connecting, by straight lines, the balls 4 and the vias, the vias and the vias, and the vias and the bond fingers 3, respectively. FIG. 13 is a diagram showing the second package substrate net information for FIG. 11. The wires and vias in FIG. 13 may be shown in different colors corresponding to each layer. Even when the design rules are satisfied, extremely complicated wires may cause a transmission error due to crosstalk. The second package substrate net information shows the complexity of the wire, thereby rearranging the complicated portions in the wires.

The wiring patterns of FIG. 11 and the package substrate net information of FIG. 12 and FIG. 13 can be displayed by the display 34 and printed by the output module 35 of FIG. 2.

As stated above, in the present embodiment, the wiring patterns of the wiring layers 21 to 24 and the dielectric layers 71 to 73 are generated on a layer-by-layer basis. Therefore, even when the number of layers is increased, the nets and wiring patterns of the package substrate 2 can be automatically generated by repeating Steps S5 to S10 in FIG. 4. Further, since the wires on the intermediate layers are generated based on the rat's nests, the length of the wires is not excessively extended. Furthermore, since the rat's nests are generated so that the number of intersections is equal to or smaller than a predetermined number, the wire can be prevented from being complicated.

Note that, in the present embodiment, the wires are sequentially generated in the direction from the bond fingers 3 to the balls 4, namely from the wiring layer 21 to the wiring layer 24. However, the wires may be sequentially generated in the direction from the balls 4 to the bond fingers 3.

Further, the present embodiment can be applied not only to the PBGA but also to the package of a multilayer substrate. For example, the present embodiment can be applied to a stacked PFBGA (Stacked die Plastic Fine Pitch Ball Grid Array) formed by mounting a plurality of stacked

IC chips on the package substrate and an EBGA (Enhanced Ball Grid Array) formed by mounting an IC chip directly on a heat sink.

At least a part of the package substrate design device and method explained in the above embodiments can be formed of hardware or software. When the package substrate design device and method is partially formed of the software, it is possible to store a program implementing at least a partial function of the package substrate design device and method in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the package substrate design device and method can be distributed through a communication line (including radio communication) such as the Internet etc. Furthermore, the program which is encrypted, modulated, or compressed can be distributed through a wired line or a radio link such as the Internet etc. or through the recording medium storing the program. While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the sprit of the inventions. The accompanying claims and their equivalents are intended to cover such forms or modifications as would fall within the scope and sprit of the inventions.

1. A package substrate design device for generating nets through a dielectric substrate having first to n-th (n is an integer of 3 or greater) wiring layers and first to (n−1)-th dielectric layers each being inserted between the wiring layers adjacent to each other, the nets being generated between a plurality of first terminals formed on the top surface of the first wiring layer of the dielectric substrate and a plurality of second terminals formed on the bottom surface of the n-th wiring layer of the dielectric substrate, comprising:
a first wiring module configured to generate, through the first dielectric layer, a plurality of first vias configured to connect wires on the first wiring layer and wires on the second wiring layer and configured to generate, on the first wiring layer, a plurality of first wires configured to connect the first vias and the first terminals;
a net generator configured to generate nets for connecting the second terminals and k-th (k is an integer of 1 to (n−2)) vias;
a second wiring module configured to generate, through the (k+1)-th dielectric layer, a plurality of (k+1)-th vias configured to connect wires on the (k+1)-th wiring layer and wires on the (k+2)-th wiring layer and configured to generate, on the (k+1)-th wiring layer, a plurality of (k+1)-th wires configured to connect the (k+1)-th vias and the k-th vias, the (k+1)-th vias and the (k+1)-th wires being generated between the k-th vias and the second terminals connected by the nets; and
a third wiring module configured to generate, on the n-th wiring layer, a plurality of n-th wires configured to connect the (n−1)-th vias and the second terminals.

2. The device of claim 1, wherein the second wiring module generates the (k+1)-th vias and (k+1)-th wires in such a manner that a predetermined design rule is satisfied.

3. The device of claim 1, wherein the net generator generates the nets in such a manner that a number of intersections of the nets is equal to or smaller than a predetermined value.

4. The device of claim 3, wherein the net generator is configured to generate straight-line nets between the second terminals and the k-th vias, is configured to count the number of intersections of the straight-line nets, and is configured to interchanging the straight-line nets intersecting each other until the number of intersections of the nets is equal to or smaller than the predetermined number when the count value exceeds the predetermined number.

5. The device of claim 1, wherein the net generator generates the nets in such a manner that the number of intersections of the nets is a smallest value.

6. The device of claim 1 further comprising a net information generator configured to generate first substrate net information where the first terminals and the second terminals are connected, the second terminals being connected to the first terminals through the first to n-th wires and the first to (n−1)-th vias.

7. The device of claim 1 further comprising a net information generator configured to generate second net information where the first terminals and the first vias, the k-th vias and the (k+1)-th vias, and the (n−1)-th vias and the second terminals are connected, respectively.

8. A package substrate design method for generating nets through a dielectric substrate having first to n-th (n is an integer of 3 or greater) wiring layers and first to (n−1)-th dielectric layers each being inserted between the wiring layers adjacent to each other, the nets being generated between a plurality of first terminals formed on the top surface of the first wiring layer of the dielectric substrate and a plurality of second terminals formed on the bottom surface of the n-th wiring layer of the dielectric substrate, comprising:
generating, through the first dielectric layer, a plurality of first vias configured to connect wires on the first wiring layer and wires on the second wiring layer and generating, on the first wiring layer, a plurality of first wires configured to connect the first vias and the first terminals;
generating nets for connecting the second terminals and k-th (k is an integer of 1 to (n−2)) vias;
generating, through the (k+1)-th dielectric layer, a plurality of (k+1)-th vias configured to connect wires on the (k+1)-th wiring layer and wires on the (k+2)-th wiring layer and generating, on the (k+1)-th wiring layer, a plurality of (k+1)-th wires configured to connect the (k+1)-th vias and the k-th vias, the (k+1)-th vias and the (k+1)-th wires being generated between the k-th vias and the second terminals connected by the nets; and
generating, on the n-th wiring layer, n-th wires configured to connect the (n−1)-th vias and the second terminals.

9. The method of claim 8, wherein upon generating the (k+1)-th vias and the (k+1)-th wires, the (k+1)-th vias and the (k+1)-th wires are generated in such a manner a predetermined design rule is satisfied.

10. The method of claim 8, wherein upon generating the nets, the nets are generated in such a manner a number of intersections of the nets is equal to or smaller than a predetermined value.

11. The method of claim 10, wherein upon generating the nets comprising:
generating straight-line nets between the second terminals and the k-th vias;
counting the number of intersections of the straight-line nets; and
when the count value exceeds the predetermined number, interchanging the straight-line nets intersecting each other until the number of intersections of the nets is equal to or smaller than the predetermined number.

12. The method of claim 8, wherein upon generating the nets, the nets are generated in such a manner the number of intersections of the nets is a smallest value.

13. The method of claim 8, further comprising generating first substrate net information where the first terminals and the second terminals are connected, the second terminals being connected to the first terminals through the first to n-th wires and the first to (n−1)-th vias.

14. The method of claim 8, further comprising generating second substrate net information where the first terminals and the first vias, the k-th vias and the (k+1)-th vias, and the (n−1)-th vias and the second terminals are connected, respectively.

15. A computer readable recording medium for recording a package substrate design program for generating nets through a dielectric substrate having first to n-th (n is an integer of 3 or greater) wiring layers and first to (n−1)-th dielectric layers each being inserted between the wiring layers adjacent to each other, the nets being generated between a plurality of first terminals formed on the top surface of the first wiring layer of the dielectric substrate and a plurality of second terminals formed on the bottom surface of the n-th wiring layer of the dielectric substrate,
wherein the package substrate design program comprises:
generating, through the first dielectric layer, a plurality of first vias configured to connect wires on the first wiring layer and wires on the second wiring layer and generating, on the first wiring layer, a plurality of first wires configured to connect the first vias and the first terminals;
generating nets for connecting the second terminals and k-th (k is an integer of 1 to (n−2)) vias;
generating, through the (k+1)-th dielectric layer, a plurality of (k+1)-th vias configured to connect wires on the (k+1)-th wiring layer and wires on the (k+2)-th wiring layer and generating, on the (k+1)-th wiring layer, a plurality of (k+1)-th wires configured to connect the (k+1)-th vias and the k-th vias, the (k+1)-th vias and the (k+1)-th wires being generated between the k-th vias and the second terminals connected by the nets; and
generating, on the n-th wiring layer, n-th wires configured to connect the (n−1)-th vias and the second terminals.

16. The medium of claim 15, wherein upon generating the (k+1)-th vias and the (k+1)-th wires, the (k+1)-th vias and the (k+1)-th wires are generated in such a manner a predetermined design rule is satisfied.

17. The medium of claim 15, wherein upon generating the nets, the nets are generated in such a manner a number of intersections of the nets is equal to or smaller than a predetermined value.

18. The medium of claim 17, wherein upon generating the nets comprising:
generating straight-line nets between the second terminals and the k-th vias;
counting the number of intersections of the straight-line nets; and
when the count value exceeds the predetermined number, interchanging the straight-line nets intersecting each other until the number of intersections of the nets is equal to or smaller than the predetermined number.

19. The medium of claim 15, wherein upon generating the nets, the nets are generated in such a manner the number of intersections of the nets is a smallest value.

20. The medium of claim 15, further comprising generating first substrate net information where the first terminals and the second terminals are connected, the second terminals being connected to the first terminals through the first to n-th wires and the first to (n−1)-th vias.
